(19) United States
(12) Patent Application Publication
(10) Pub. No.: US 2022/0333873 A1
(43) Pub. Date: Oct. 20, 2022

(54) BRAZING STRUCTURE FOR FLAT TUBE AND HEADER PLATE OF HEAT EXCHANGER

(71) Applicant: T.RAD CO., LTD., Tokyo (JP)

(72) Inventors: Akira KOMURO, Tokyo (JP); Taiji SAKAI, Tokyo (JP); Atsushi OKUBO, Tokyo (JP)

(21) Appl. No.: 17/641,150

(22) PCT Filed: Sep. 18, 2020
(86) PCT No.: PCT/JP2020/037043

§ 371 Date: Mar. 8, 2022

(30) Foreign Application Priority Data
Sep. 20, 2019 (JP) 2019-172098

(51) Int. Cl. F28F 1/02; F28F 9/02

(52) U.S. Cl. CPC F28F 1/02; F28F 9/02; F28F 2275/04

(57) ABSTRACT

The present invention reduces and mitigates thermal stress generated at joint portions between a header plate and a flat tube of a heat exchanger. In a direction of a vertical center axis passing the center of the inside of a flat tube, positions of first brazing parts are set to be closer to the center of the flat tube in the direction of the vertical center axis than positions of edge brazing parts. Accordingly, the thermal stress concentrated at the joint portions between short sides of the flat tube and the header plate is dispersed to other portions.

### TECHNICAL FIELD

The present invention relates to a brazing structure for a flat tube and a header plate of a heat exchanger.

### BACKGROUND ART

A thermal cycle of a heat exchanger having a header plate causes a concentration of thermal stress in joint portions between short sides of a flat tube and the header plate, which may result in cracks on the flat tube around the joint portions.

In order to reduce the concentration of thermal stress, Patent Literature 1 discloses the heat exchanger having the header plate with cross section formed in a trapezoidal shape that is convex in a direction away from the header tank.

### CITATION LIST

### Patent Literature

[Patent literature 1] Japanese Patent No. 397460

### SUMMARY

### Technical Problem

However, the heat exchanger disclosed in Patent Literature 1 tends to cause a high thermal stress in joint portions between centers of long sides of a flat tube and the header plate.

The present invention is directed to provide the heat exchanger reducing the thermal stress on the joint portions between the flat tube and the header plate including the above portions.

### Solution to Problem

The present invention according to a first aspect thereof provides a brazing structure for a flat tube and a header plate of a heat exchanger including: the flat tube 3 having a pair of flat portions 1 opposing each other and a pair of connecting portions 2 connecting between the pair of flat portions 1; and the header plate 5 having a plurality of insertion holes 4 separately arranged in a longitudinal direction of the header plate 5. Edges of the flat tube 3 are inserted through the insertion hole 4. The insertion hole 4 and an outer surface of the flat tube 3 are brazed each other. The flat tube 3 has a vertical center axis 6 passing through a center of the flat tube 3 inside the flat tube 3 and a horizontal center axis 7 perpendicular to the vertical center axis 6 and parallel to a flat surface of the flat tube 3. At least one of the flat tubes 3 has an edge brazing part 8 located on the each edge of the flat tubes 3 in the direction of horizontal center axis 7 and a first brazing part 10 adjacent to the edge brazing part 8. The first brazing part 10 is located closer to the center of the flat tube 3 in the direction of the vertical center axis 6 than a position of the edge brazing part 8.

The present invention according to a second aspect thereof is the brazing structure for the flat tube and the header plate of the heat exchanger according to the first aspect, wherein:

the first brazing part 10 is located closer to the center of the flat tube 3 in the direction of the vertical center axis 6 than the position of the edge brazing part 8 on the outermost flat tube 3 in the parallelly arranged flat tubes 3.

The present invention according to a third aspect thereof is the brazing structure for the flat tube and the header plate of the heat exchanger according to the first aspect, wherein:

the flat tube 3 has a second brazing part 9, and the first brazing part 10 may be located closer to the center of the flat tube 3 in the direction of the vertical center axis 6 than the position of the second brazing part 9.

The present invention according to a fourth aspect thereof is the brazing structure for the flat tube and the header plate of the heat exchanger according to the third aspect, wherein:

the flat tube 3 has a column portion 14 connecting inner surfaces of the flat portions 1, and at least one of the column portions 14 may be located at the second brazing part 9.

### Advantageous Effects of Invention

The invention according to the first aspect is an invention, wherein:

the first brazing part 10 is located closer to the center of the flat tube 3 in the direction of the vertical center axis 6 than the position of the edge brazing part 8.

Since the thermal stress applies mainly to the first brazing part 10 in this brazing structure, the thermal stress at the edge brazing part 8 is reduced.

The invention according to the second aspect is an invention, wherein:

the first brazing part 10 is located closer to the center of the flat tube 3 in the direction of the vertical center axis 6 than the position of the edge brazing part 8 on the outermost flat tube 3 in the parallelly arranged flat tubes 3.

The higher thermal stress tends to be concentrated at the outermost flat tube 3 compared with the other parallelly arranged flat tubes 3. This brazing structure reduces the concentration of thermal stress at the brazing parts between the outermost flat tube 3 in the parallelly arranged flat tubes 3 and the header plate 5.

The invention according to the third aspect is an invention, wherein:

the flat tube 3 has a second brazing part 9, and the first brazing part 10 may be located closer to the center of the flat tube 3 in the direction of the vertical center axis 6 than the position of the second brazing part 9.

This brazing structure reduces the concentration of thermal stress at the brazing parts between the centers of the flat portions 1 of the flat tube 3 and the header plate 5.

The invention according to the fourth aspect is an invention, wherein:

the flat tube 3 has a column portion 14 connecting inner surfaces of the flat portions 1, and at least one of the column portions 14 may be located at the second brazing part 9.

This brazing structure reduces the concentration of thermal stress at the brazing parts between the portions around the column portions 14 on the flat tube 3 and the header plate 5.

### BRIEF DESCRIPTION OF DRAWINGS

FIG. 1 is a perspective view of a main part illustrating a brazing structure for a flat tube and a header plate of a heat exchanger in Embodiment 1 of the present invention.

FIGS. 2A and 2B are cross-sectional views and FIG. 2C is a perspective view showing each part along a lateral direction of the header plate 5 shown in FIG. 1.

FIGS. 3A to 3C are cross-sectional views showing each part along a longitudinal direction of the header plate 5 shown in FIG. 1.

FIGS. 4A and 4B show a state of stress concentration in the brazing structure of the heat exchanger in Embodiment 1.

FIGS. 5A and 5B show the state of stress concentration in the brazing structure of a conventional heat exchanger.

FIG. 6A is a perspective view illustrating the brazing structure for the flat tube and the header plate of the heat exchanger in Embodiment 2 and FIG. 6B is a plan view of the flat tube 3 shown in FIG. 6A.

FIGS. 7A and 7B are cross-sectional views and FIG. 7C is a perspective view showing each part along a lateral direction of the header plate 5 shown in FIG. 6A.

FIGS. 8A to 8C are cross-sectional views showing each part along a longitudinal direction of the header plate 5 shown in FIG. 6A.

FIG. 9 is a cross-sectional view of the main part illustrating Embodiment 3.

FIG. 10 is a cross-sectional view of the main part illustrating Embodiment 4.

FIG. 11 is a cross-sectional view of the main part illustrating Embodiment 5.

FIG. 12 is a cross-sectional view of the main part illustrating Embodiment 6.

FIG. 13 is a cross-sectional view of the main part illustrating Embodiment 7.

FIG. 14 is a cross-sectional view of the main part illustrating Embodiment 8.

FIG. 15 is a cross-sectional view of the main part illustrating Embodiment 9.

FIG. 16 is a cross-sectional view of the main part illustrating Embodiment 10.

### DESCRIPTION OF EMBODIMENT

Embodiments of the present invention will be described below by using appended drawings.

### Embodiment 1

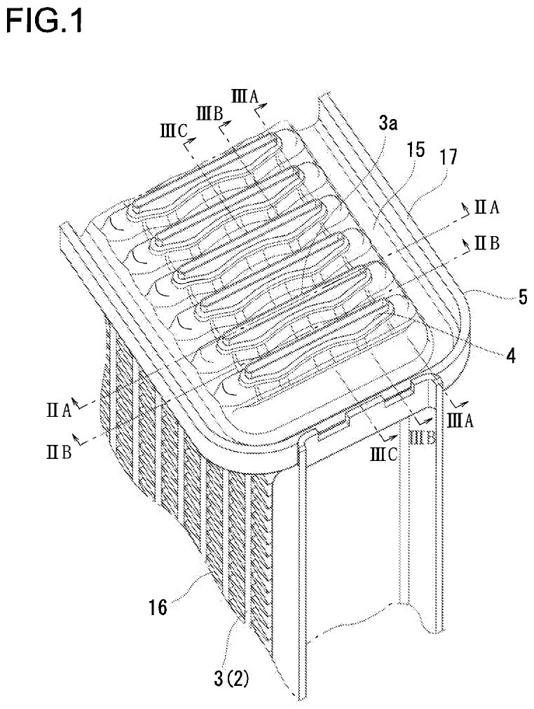

FIGS. 1 to 3C illustrates Embodiment 1 of the present invention.

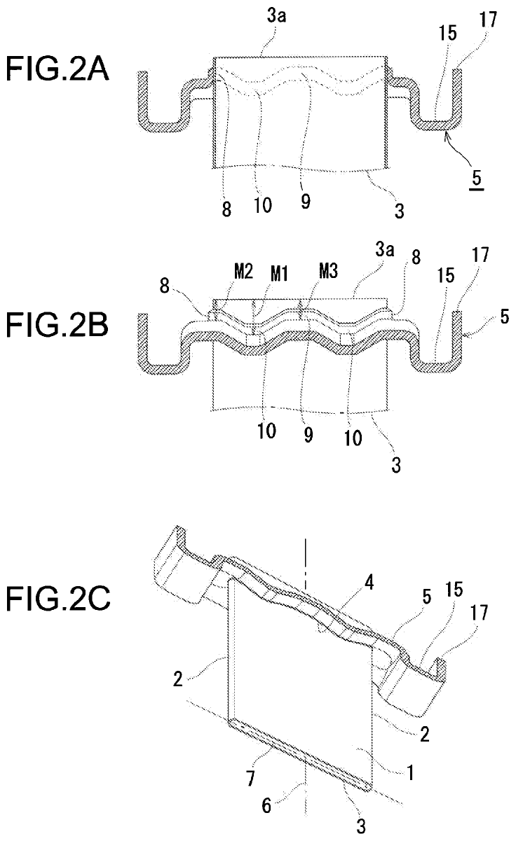

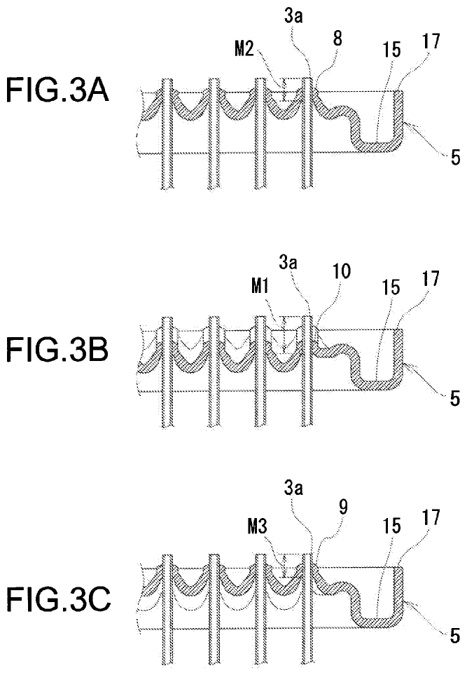

FIG. 1 is a perspective view of a main part illustrating a brazing structure for a flat tube and a header plate. FIGS. 2A to 2C are cross-sectional views and a perspective view showing each part along a lateral direction of the header plate 5 shown in FIG. 1. FIG. 2A is a cross-sectional view taken from line IIA-IIA in FIG. 1, FIG. 2B is a cross-sectional view taken from line IIB-IIB in FIG. 1, and FIG. 2C is a perspective view of the brazing structure as viewed from the bottom surface of the header plate 5 shown in FIG. 1. FIGS. 3A to 3C are cross-sectional views showing each part along a longitudinal direction of the header plate 5 shown in FIG. 1. FIG. 3A is a cross-sectional view taken from line IIIA-IIIA in FIG. 1, FIG. 3B is a cross-sectional view taken from line IIIB-IIIB in FIG. 1, and FIG. 3C is a cross-sectional view taken from line IIIC-IIIC in FIG. 1.

A heat exchanger of this embodiment includes the flat tubes 3 arranged in parallel, both edges of the flat tubes 3 are inserted through the insertion holes 4 arranged in parallel along a longitudinal direction of the header plate 5, and the insertion portions are brazed. The insertion holes 4 are arranged so that their vertical axes are located in a lateral direction of the header plate 5.

Each of the flat tubes 3 has a pair of flat portions 1 opposing each other and a pair of connecting portions 2 connecting between the pair of flat portions 1. As shown in FIG. 1, the connecting portion 2 may have a cross section formed in an arc shape. As shown in FIG. 2C, the flat tube 3 has a vertical center axis 6 passing through the vertical center of the flat tube 3 and a horizontal center axis 7 perpendicular to the vertical center axis 6.

As shown in FIG. 1, fins 16 formed in a corrugated shape may be arranged between the flat tubes 3.

An annular groove 15 is formed along the peripheral of the header plate 5, and a side wall 17 is raised from the peripheral edge of the header plate 5 toward a small flange of a tank (not shown). The insertion holes 4 separately arranged in a longitudinal direction of the header plate 5 are formed inside the annular groove 15 in the lateral direction.

An opening of the tank may be fitted into the annular groove 15 using a seal ring (not shown), and may be caulked and fixed to the edge of the small flange of the tank by a caulking claw (not shown) formed on the edge of the side wall 17.

As shown in FIGS. 2A to 2C, the surface inside the annular groove 15 of the header plate 5 is formed as a wave form cross section. The insertion holes 4 are formed on the surface having the wave form cross section on the header plate 5, and burring parts protruding inside the tank are formed around there by a burring processing. Their burring heights correspond to the height of the wave form on the surface of the head plate 5.

Brazing parts between the flat tube 3 and the header plate 5 include a second brazing part 9 located at the center of the wave form surface, first brazing parts 10 located at the both sides of the second brazing part 9, and edge brazing parts 8 located at the both edge of the flat tube 3. The brazing parts 8, 9, and 10 continuously form a brazing line.

As shown in FIGS. 2A to 3C, M1 indicates a length from an opening edge 3a to the first brazing part 10, M2 indicates the length to the edge brazing part 8, and M3 indicates the length to the second brazing part 9.

In this embodiment, the length M1 from the opening edge 3a to the first brazing part 10 is longer than the length M2 to the edge brazing part 8, and the length M3 to the second brazing part 9 is shorter than the length M1 to the first brazing part.

Therefore, the first brazing part 10 is located closer to the center of the flat tube 3 in the direction of the vertical center axis 6 passing through the center of the flat tube 3 than a position of the edge brazing part 8, and the first brazing part 10 is located closer to the center of the flat tube 3 in the direction of the vertical center axis 6 of the flat tube 3 than the position of the second brazing part 9.

Although the length M2 from the opening edge 3a to the edge brazing part 8 almost equals to the length M3 to the second brazing part 9 in FIGS. 1 to 3C, a relation between the length M2 to the edge brazing part 8 and the length M3 to the second brazing part 9 is not limited to this.

The relation between the position of the brazing part 8 and the position of the second brazing part 9 in the direction of the vertical center axis 6 is not limited to a case shown in FIGS. 1 to 3C.

Moreover, since the similar brazing lines are formed on the flat tubes 3 arranged in parallel, protruding lengths of flat tubes 3 from the insertion holes 4 are almost same.

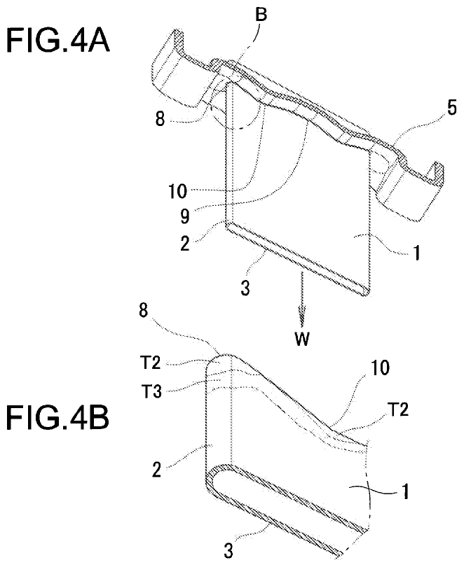

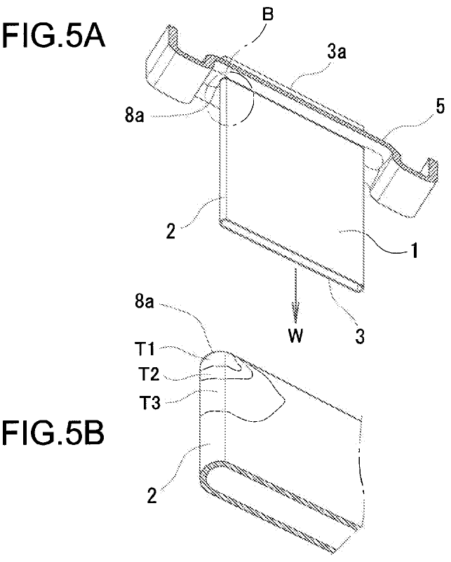

Functions and effects of this embodiment will be described below according to FIGS. 4A to 5B.

FIG. 4A is a perspective view as viewed from the bottom surface of the header plate 5, and FIG. 4B is a contour map illustrating a state of stress concentration as viewed from the same position. On the other hand, FIG. 5A is a perspective view as viewed from bottom surface of a header plate 5 of a conventional heat exchanger, and FIG. 5B is a contour map illustrating the state of stress concentration as viewed from the same position.

The states of stress concentration at positions B at the header plates 5 and the flat tubes 3 are compared between the wave form brazing line of Embodiment 1 of the present invention (see FIG. 4A) and a linear brazing line (see FIG. 5A).

In the case of the linear brazing line of the conventional heat exchanger shown in FIG. 5A, a highest thermal stress region T1 is generated in a strip shape around a root portion between the connecting portion 2 of the flat tube 3 and header plate 5 (the position of the edge brazing part 8a in FIG. 5B), a second highest thermal stress region T2 is generated around T1, and a third highest thermal stress region T3 is generated around T2 as shown in FIG. 5B.

On the other hand, in the case of the wave form brazing line of the present invention shown in FIG. 4A, the thermal stress concentration is reduced shown in FIG. 4B and the highest thermal stress region T1 generated on the flat tube 3 of the conventional heat exchanger cannot be observed.

This is because of a configuration on the wave form brazing line in which the edge brazing parts 8 are located relatively near from the opening edge 3a of the flat tube 3, the first brazing parts 10 are located further, and the second brazing part 9 at the center of the opening edge 3a is located relatively closer. The configuration disperses the high thermal stress generated at the edge brazing parts 8 on the first brazing parts 10, which results in reducing the thermal stress generated at the edge brazing parts 8. For the same reason, the thermal stress generated at the second brazing part 9 can be also reduced.

Thus, the thermal stress concentration generated in the flat tube 3 is reduced in the present invention.

Although the brazing lines of all flat tubes 3 are formed in the same shape in Embodiment 1 as shown FIG. 1, only an outermost flat tube 3 may be formed in the wave form brazing line. Two, three, or four flat tubes 3 from outermost may be also formed in the wave form brazing lines.

This results in reducing the thermal stress of the outermost flat tube 3 which tends to be higher than other flat tubes 3.

### Embodiment 2

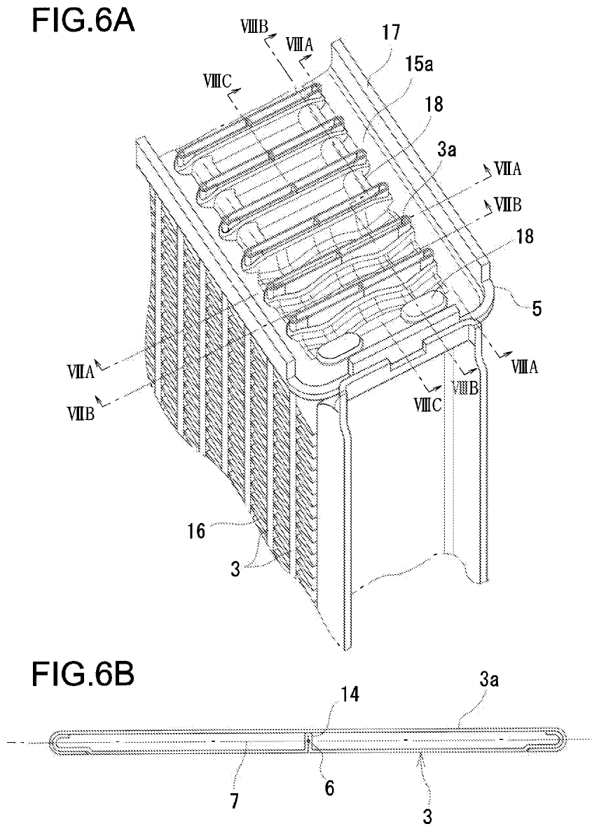

FIGS. 6A to 8C illustrate Embodiment 2 of the present invention. The annular groove 15 is formed in along the peripheral of the header plate 5 in this embodiment.

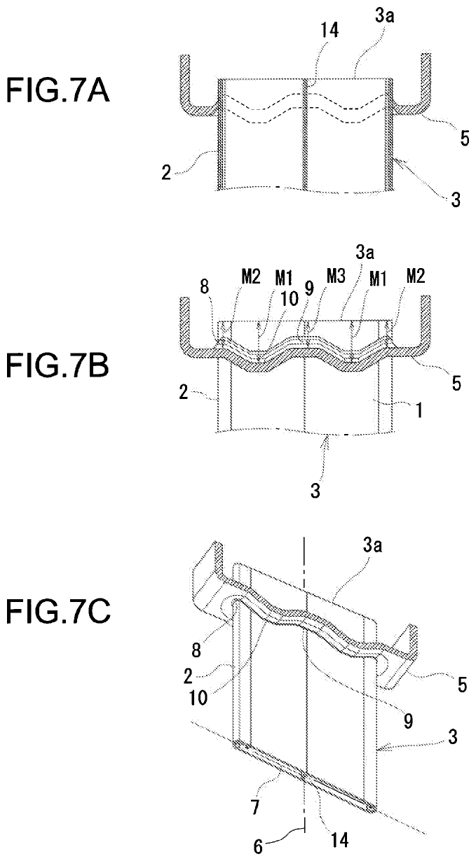

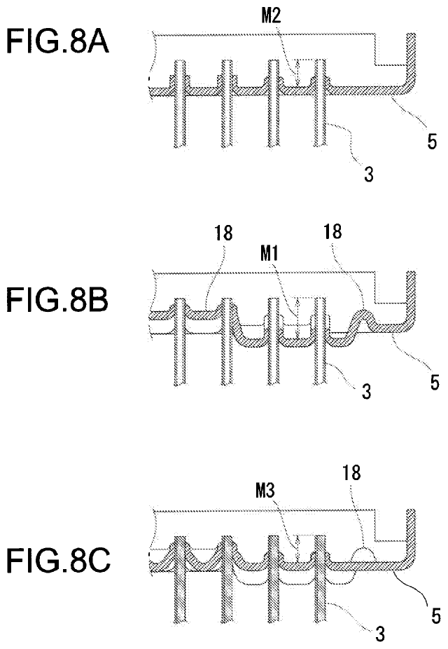

FIG. 6A is a perspective view illustrating the brazing structure for the flat tube and the header plate of the heat exchanger in Embodiment 2 of the present invention and FIG. 6B is a plan view of the flat tube 3 shown in FIG. 6A. FIG. 7A is a cross-sectional view taken from line VIIA-VIIA in FIG. 6A, FIG. 7B is a cross-sectional view taken from line VIIB-VIIB in FIG. 6A, and FIG. 7C is a perspective view of the brazing structure as viewed from the bottom surface of the header plate 5. FIG. 8A is a cross-sectional view taken from line VIIIA-VIIIA in FIG. 6A, FIG. 8B is a cross-sectional view taken from line VIIIB-VIIIB in FIG. 6A, and FIG. 8C is a cross-sectional view taken from line VIIIC-VIIIC in FIG. 6A.

As described above, an annular groove corresponding portion 15a shown in FIG. 6A is formed in flat along the peripheral of the header plate 5 in this embodiment.

The both edges in the longitudinal direction of header plate 5 are bent in round same as FIG. 1. In addition, the insertion holes 4 and the brazing lines on the header plate 5 are formed in the wave form. The edge brazing parts 8, the first brazing parts 10, and the second brazing part 9 continuously form the brazing line same as Embodiment 1.

As shown in FIG. 6B, a column portion 14 perpendicular to the horizontal center axis 7 is disposed on the vertical center axis 6 of the each flat tube 3 in this embodiment.

The flat tube 3 is formed by rolling and pressing a pair of plates in this embodiment.

Convex portions 18 are protruded from the surface of the header plate 5 toward the tank between the flat tubes 3 without two flat tubes 3 from outermost. The seal rings are disposed between the convex portions 18 and the edge of the header plate 5.

As shown in FIG. 7A, a high stiffness of the portion reinforced by the column portion 14 restrict a thermal deformation, which results in increasing the thermal stress around the column portion 14 in this embodiment.

However, since the second brazing part 9 in the brazing line is located on the position of column portion 14 of the flat tube 3, the configuration disperses the high thermal stress generated at the second brazing part 9 on the first brazing parts 10, which results in decreasing the stress generated at the first brazing part 9 around the column portion 14 and reducing the stress concentration.

### Embodiment 3

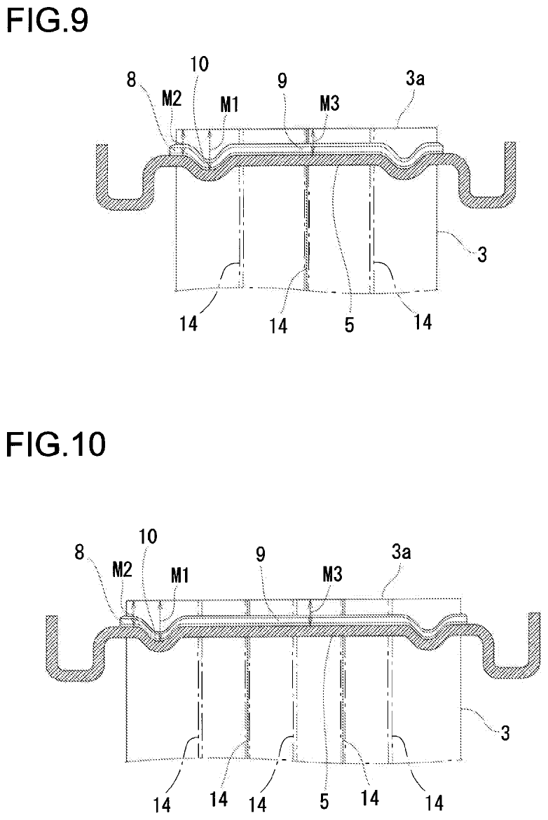

FIG. 9 is a cross-sectional view of the main part illustrating Embodiment 3.

The annular groove 15 is formed along the peripheral of the header plate 5 in this embodiment same as Embodiment 1 shown in FIGS. 1 to 3C.

This embodiment is different from Embodiment 1 in that three column portions 14 are formed and the second brazing part 9 is located at the positions of the column portions 14.

The stress concentration is reduced in this embodiment same as Embodiment 1.

### Embodiment 4

A number of the column portions 14 is not limited to three. As shown in FIG. 10 (Embodiment 4), any number of the column portions 14 may be formed.

### Embodiment 5

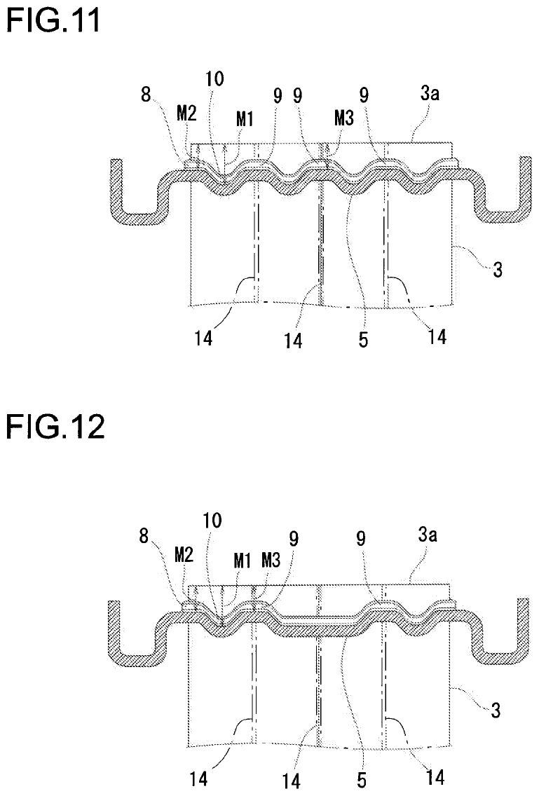

FIG. 11 is a cross-sectional view of the main part illustrating Embodiment 5.

This embodiment is different from Embodiment 3 in that there are three second brazing parts 9 and the second brazing parts 9 are located at each of the three positions of the column portions 14.

The stress concentration is reduced in this embodiment same as Embodiment 3.

### Embodiment 6

FIG. 12 is a cross-sectional view of the main part illustrating Embodiment 6.

This embodiment is different from Embodiment 5 in that there are two second brazing parts 9 and the second brazing parts 9 are located at two of the three positions of the column portions 14.

The stress concentration around the above two column portions 14 are reduced in this embodiment same as Embodiment 5.

### Embodiment 7

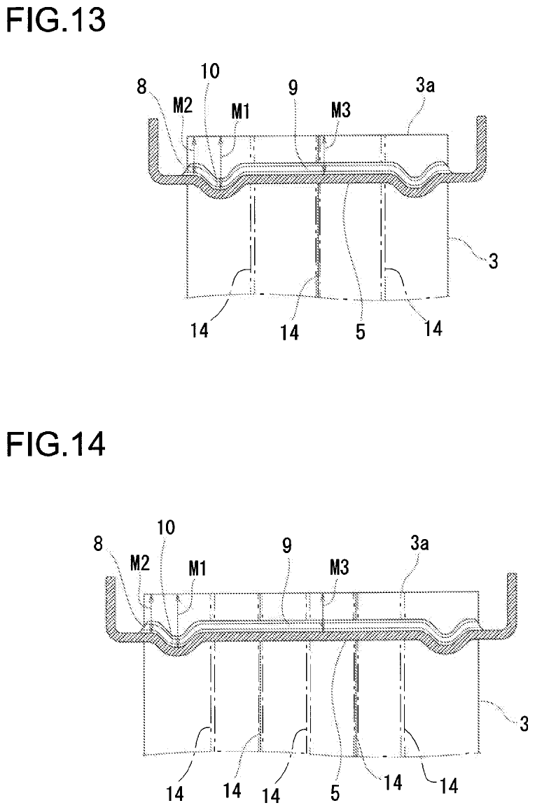

FIG. 13 is a cross-sectional view of the main part illustrating Embodiment 7.

The annular groove corresponding portion 15a shown in FIGS. 6A to 8C of Embodiment 2 is formed in flat along the peripheral of the header plate 5 in this embodiment.

This embodiment is different from Embodiment 2 in that three column portions 14 are formed and the second brazing part 9 is located at the positions of the column portions 14.

The stress concentration is reduced in this embodiment same as Embodiment 2.

### Embodiment 8

The number of the column portions 14 is not limited to three. As shown in FIG. 14 (Embodiment 8), any number of the column portions 14 may be formed.

### Embodiment 9

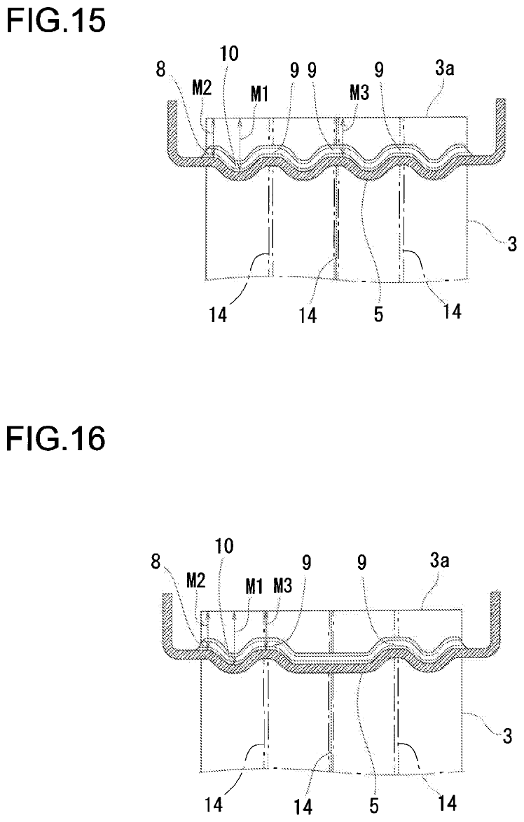

FIG. 15 is a cross-sectional view of the main part illustrating Embodiment 9.

This embodiment is different from Embodiment 7 in that there are three second brazing parts 9 and the second brazing parts 9 are located at each of the three positions of the column portions 14.

The stress concentration is reduced in this embodiment same as Embodiment 7.

### Embodiment 10

FIG. 16 is a cross-sectional view of the main part illustrating Embodiment 10.

This embodiment is different from Embodiment 9 in that there are two second brazing parts 9 and the second brazing parts 9 are located at two of the three positions of the column portions 14.

The stress concentration around the above two column portions 14 are reduced in this embodiment same as Embodiment 9.

### INDUSTRIAL APPLICABILITY

The present invention can be applied to the heat exchangers, such as radiators.

### REFERENCE SIGNS LIST

1 flat portion
2 connecting portion
3 flat tube
3a opening edge
4 insertion hole
5 header plate
6 vertical center axis
7 horizontal center axis
8 edge brazing part
8a edge brazing part
9 second brazing part
10 first brazing part
14 column portion
14a intermediate column portion
15 annular groove
15a annular groove corresponding portion
16 fin
17 side wall
18 convex portion
M1-M3 length
T1-T3 region

1. A brazing structure for a flat tube and a header plate of a heat exchanger, comprising:
the flat tube having a pair of flat portions opposing each other and a pair of connecting portions connecting between the pair of flat portions; and
the header plate having a plurality of insertion holes separately arranged in a longitudinal direction of the header plate;
wherein edges of the flat tube are inserted through the insertion hole,
the insertion hole and an outer surface of the flat tube are brazed each other,
the flat tube has a vertical center axis passing through a center of the flat tube inside the flat tube and a horizontal center axis perpendicular to the vertical center axis and parallel to a flat surface of the flat tube,
at least one of the flat tubes has an edge brazing part located on the each edge of the flat tubes in the direction of horizontal center axis and a first brazing part adjacent to the edge brazing part, and
the first brazing part is located closer to the center of the flat tube in the direction of the vertical center axis than a position of the edge brazing part.

2. The brazing structure for the flat tube and the header plate of the heat exchanger according to claim 1,
wherein the first brazing part is located closer to the center of the flat tube in the direction of the vertical center axis than the position of the edge brazing part on the outermost flat tube in the parallelly arranged flat tubes.

3. The brazing structure for the flat tube and the header plate of the heat exchanger according to claim 1,
wherein the flat tube has a second brazing part, and
the first brazing part is located closer to the center of the flat tube in the direction of the vertical center axis than the position of the second brazing part.

4. The brazing structure for the flat tube and the header plate of the heat exchanger according to claim 3,
wherein the flat tube has a column portion connecting inner surfaces of the flat portions, and
at least one of the column portions is located at the second brazing part.
